(19) United States
(12) Patent Application Publication
(10) Pub. No.: US 2015/0323965 A1
(43) Pub. Date: Nov. 12, 2015

(54) SELF-PROFILING FRICTION PADS FOR ELECTRONIC DEVICES

(71) Applicant: Apple Inc., Cupertino, CA (US)

(72) Inventors: James R. KROGDAHL, Cupertino, CA (US); Adam T. GARELLI, Santa Clara, CA (US); Bruce E. BERG, Encinitas, CA (US); Liliya LYANDRES, San Jose, CA (US); William F. LEGGETT, San Francisco, CA (US); Paul CHOINIERE, Livermore, CA (US)

(73) Assignee: Apple Inc., Cupertino, CA (US)

(21) Appl. No.: 14/274,452

(22) Filed: May 9, 2014

(51) Int. Cl. G06F 1/18; B05D 3/10; G06F 1/16

(52) U.S. Cl. CPC G06F 1/182; G06F 1/1613; B05D 3/102

(57) ABSTRACT

This application relates to self-profiling friction pads for computing devices. In particular, the embodiments discussed herein describe self-profiling friction pads that have a naturally dome-shaped profile. In some embodiments, the self-profiling friction pads can be used as device feet for a computing device. Additionally, the self-profiling friction pads can be used to seal certain areas of the computing device such as a display or ventilation system. The self-profiling friction pads are configured to be deposited in a liquid state and form into a dome shape as a result of the material properties of the deposited liquid and the properties of the surface to which the liquid is deposited.

### FIELD

The described embodiments relate generally to friction pads. More particularly, the present embodiments relate to self-profiling friction pads for electronic devices.

### BACKGROUND

Recent advances in device manufacturing have led to more aesthetically pleasing and durable computing devices. Smooth surfaces and seamless joints are just some examples of features that can contribute to creating an aesthetically pleasing and structurally sound computing device. However, such features can come at a cost and end up subjecting the computing device to hazardous conditions. For example, designing a shock absorber on the bottom of a device to be as smooth as possible can defeat the purpose of the shock absorber when there is limited material available to absorb impact. Moreover, if the shock absorber is mounted through an aperture of the computing device housing to create a seamless appearance, the aperture can provide a means for ingress of water and electrostatic discharge. Similarly, in laptop computing devices where a display is often closed and opened repetitively, designing a shock absorber around a perimeter of the display to be as thin as possible can lead to faster degradation of the display because less impact is absorbed by the shock absorber.

### SUMMARY

This paper describes various embodiments that relate to self-profiling friction pads. In some embodiments, a computing device housing is set forth as having a first surface, wherein the first surface includes a depressed portion that is recessed from an adjacent portion of the first surface. Additionally, the depressed portion can include a base portion and wall portion concurrently abutting a self-profiling material deposited within the depressed portion. The self-profiling material can include a thermoplastic material that is applied to the computing device housing when the thermoplastic material is in a liquid state. Moreover, the self-profiling material can, based on a material property of the depressed portion, form a dome-shaped profile across the depressed portion when the thermoplastic material transitions into a substantially solid state. Additionally, the self-profiling material can exclusively abut the first surface of the computing device.

In some embodiments, a method is set forth for applying a self-profiling pad to a surface of a computing device. The method can include a step of depositing a self-profiling material to the surface of the computing device while the self-profiling material is in a liquid state. The self-profiling material can be comprised of a thermoplastic polymer. Additionally, the method can include causing the self-profiling material to transition into a solid state and form a dome-shaped profile exclusively across a surface of the computing device.

Furthermore, in some embodiments, a self-profiling pad for a computing device is set forth. The self-profiling pad can comprise a body made of a thermoplastic material, a first surface having a dome-shaped profile, and a second surface that is substantially flat. The second surface of the self-profiling pad is configured to exclusively abut one side of a housing of the computing device. Additionally, the self-profiling pad can include a lateral portion configured to abut a depressed portion of the housing on at least two surfaces of the depressed portion.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A-1B illustrate a cross section A-A of a friction pad embedded in a computing device housing;

FIGS. 2A-2C illustrate cross-sections of various embodiments where the friction pad is deposited on surface of a device housing;

FIGS. 3A-3C illustrate cross-sections of various embodiments where the friction pad is deposited on a surface of a device housing;

FIGS. 4A-4B illustrate the friction pad deposited on a perimeter of a computing device;

FIG. 5 illustrates a cross-section of the friction pad deposited on a perimeter of a computing device;

FIGS. 6A-6B illustrate an embodiment wherein the friction pad is incorporated into a key of a keyboard;

FIG. 7 illustrates an embodiment where the friction pad is used to seal a ventilation system of a computing device; and

FIG. 8 illustrates a method for applying a friction pad to a computing device.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Computing device surfaces and joints can be made smooth and seamless for purposes of aesthetics and also for structural integrity, and protecting the interior and exterior of the computing device. In some embodiments described herein, a self-profiling friction pad is provided for protecting a surface and interior of a computing device such as a laptop. A computing device can incorporate shock absorbers for protecting various components of the computing device, however, such shock absorbers can require an aperture be machined out of a surface of the computing device for retaining the shock absorber. By using a self-profiling friction pad, and eliminating the need to machine an aperture into the computing device, opportunities for ingress of water and electrostatic discharge into the computing device are mitigated.

Self-profiling refers to the ability of a material to naturally mold itself into a shape such as a dome, plateau, or any other suitable shape for a given design when applied to a particular surface. In order to give the self-profiling friction pad a self-profiling property, the self-profiling friction pad can include a thermoplastic polymer. Thermoplastic polymers are polymers that become liquid upon heating and substantially solid upon cooling. The transition of a thermoplastic polymer between solid and liquid can be entirely reversible, making them ideal for deposition, iterative processes, and developing molds with other materials. Prior to deposition of the self-profiling friction pad onto a surface, the properties of the surface, such as surface tension, can be modified in order to further alter a natural shape of the self-profiling friction pad. In this way, the self-profiling friction pad can be made more curved or flat depending on the surface tension of the surface and the desired profile of a given computing device. Other properties of the surface can be modified to alter the natural shape of the self-profiling friction pad. For example, a machined pocket can be created in the surface to receive the thermoplastic polymer, and the surface tension of the machined pocket can be modified to ensure that the thermoplastic polymer stays within the machined pocket. Additionally, a primer or low surface energy coating can be applied to the surface or machined pocket for modifying the surface tension of the surface. By modifying a surface energy of the surface receiving the self-profiling friction pad, the dimensions and shape of the self-profiling friction pad can be modified as a result of the intermolecular forces between the self-profiling friction pad and the surface. For example, when the surface energy of the surface is modified to repel the deposited self-profiling friction pad, the self-profiling friction pad can be caused to harden into a more narrow shape. Alternatively, modifying the surface energy of the surface to not repel the deposited self-profiling friction pad can cause the self-profiling friction pad to harden into a steeper or more dome-like shape.

In some embodiments, other portions of the computing device include the thermoplastic polymer, such as a border of a keyboard on a laptop. In this way, the thermoplastic polymer can act as a cushion between the display glass and a rigid surface of the laptop keyboard further protecting the display glass against repetitive impacts while maintaining a thin profile for the laptop. In some embodiments, the thermoplastic polymer can be dispensed into the keys of a keyboard in order to provide more friction between the fingers of a user and the keys. Moreover, the thermoplastic polymer can be used to seal air ducts in the computing device by applying the thermoplastic polymer directly to various surfaces of the air duct, thereby eliminating the need to use both a glue and an elastomeric seal, or gasket, to seal the air duct.

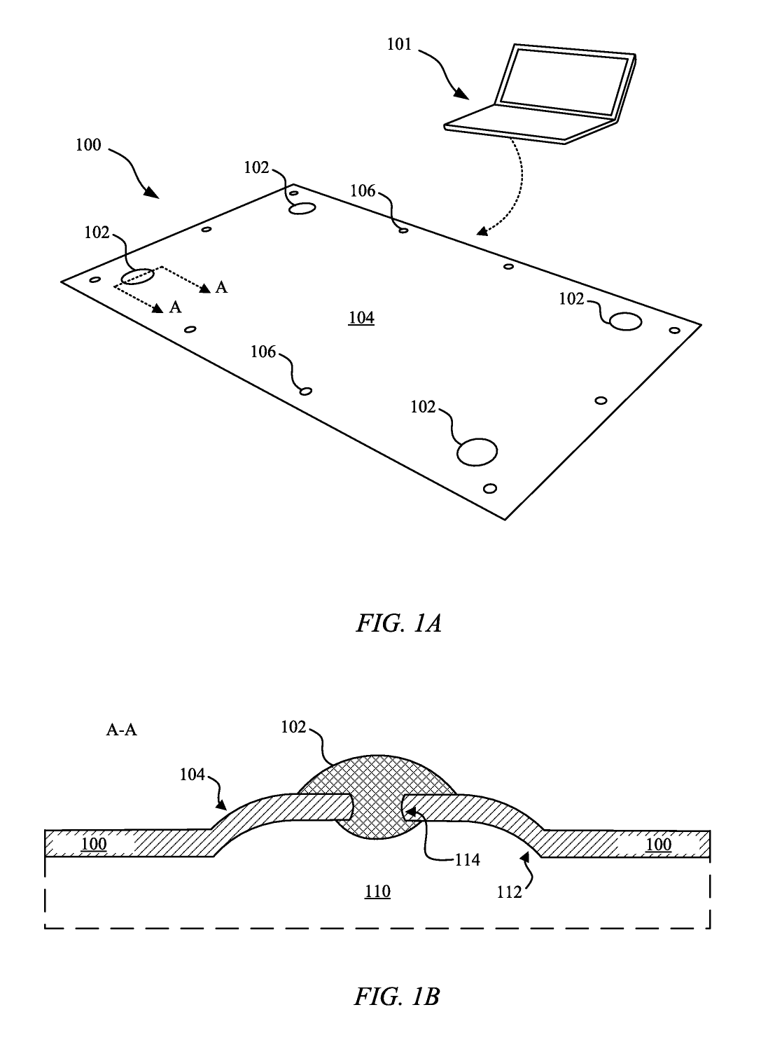

These and other embodiments are discussed below with reference to FIGS. 1A-8; however, those skilled in the art will readily appreciate that the detailed description given herein with respect to these figures is for explanatory purposes only and should not be construed as limiting.

The embodiments described herein relate to creating and depositing a friction pad on a housing of a computing device. Friction pads can be used as an interface between the computing device and a surface on which the computing device can be placed. In this way, the friction pads act as feet for the computing device. In some embodiments described herein, the friction pad can be configured between a display and housing of a laptop, into the keys of a keyboard of a computing device, or into the seals of an air duct. The advantages of incorporating the friction pad into the aforementioned areas of the computing device include at least improved aesthetics, increased friction between the computing device and an opposing surface, improving impact resistance between different components of the computing device, and minimizing the need for apertures in the housing of the computing device to secure various shock absorbing components.

FIGS. 1A and 1B illustrate a cross section A-A of a friction pad embedded in a device housing 100. In particular, FIG. 1A illustrates a device housing 100 of a computing device 101. The computing device 101 can be a phone, laptop, desktop, media player, or the like. The device housing 100 can include a plurality of screw holes 106 for which to secure the device housing 100 to the computing device 101. The device housing 100 can be formed from a single, rigid piece of material, or multiple pieces of material (e.g., layers) having a diverse composition. The materials used to form the device housing 100 can include, but are not limited to, metal, ceramic, plastic, glass, rubber, or any suitable combination thereof for housing a computing device. In some embodiments, the device housing 100 can be made from aluminum that has been anodized, or will be anodized in a later process. Anodizing is an electrolytic process that can be used to change surface features, such as thickness or corrosion resistance, of a metal.

The dimensions of the device housing 100 can vary in some embodiments. FIG. 1B illustrates an embodiment in which the device housing 100 has a first surface 104 and a second surface 112 (shown in FIG. 1B), wherein the second surface 112 is on the opposite side of the device housing 100 relative to the first surface 104. The device housing 100 can have curved features, as illustrated in FIG. 1B, which shows a cross section A-A and a profile of a friction pad 102. The friction pad 102 resides on both the first surface 104 and second surface 112. This arrangement can provide secure placement for the friction pad 102 but can also lead to water entering into an interior portion 110 of the computing device, for example, through the capillary action of water. Additionally, by incorporating a friction pad 102 that penetrates an aperture 114 of the device housing 100, a pathway can be created for electrostatic discharge (ESD) to travel into the interior portion 110 of the computing device through the aperture 114.

The embodiments described herein are set forth to cure at least the aforementioned deficiencies of the friction pad design of FIG. 1B. In particular, the embodiments described herein include a variety of self-profiling friction pads that do not require an opening for the self-profiling friction pads to reside, such as the aperture 114 of FIG. 1B. Instead, some embodiments described herein can include a friction pad that abuts exclusively one side of the device housing 100. In this way, water ingress and ESD are mitigated through areas of the computing device that may have previously been designed as openings. Additionally, because of the nature of the materials used to create the friction pads set forth herein, a naturally thin, domed profile can be provided by the friction pads in order to maintain a sleek and narrow design for the computing device, while also providing various structural incentives.

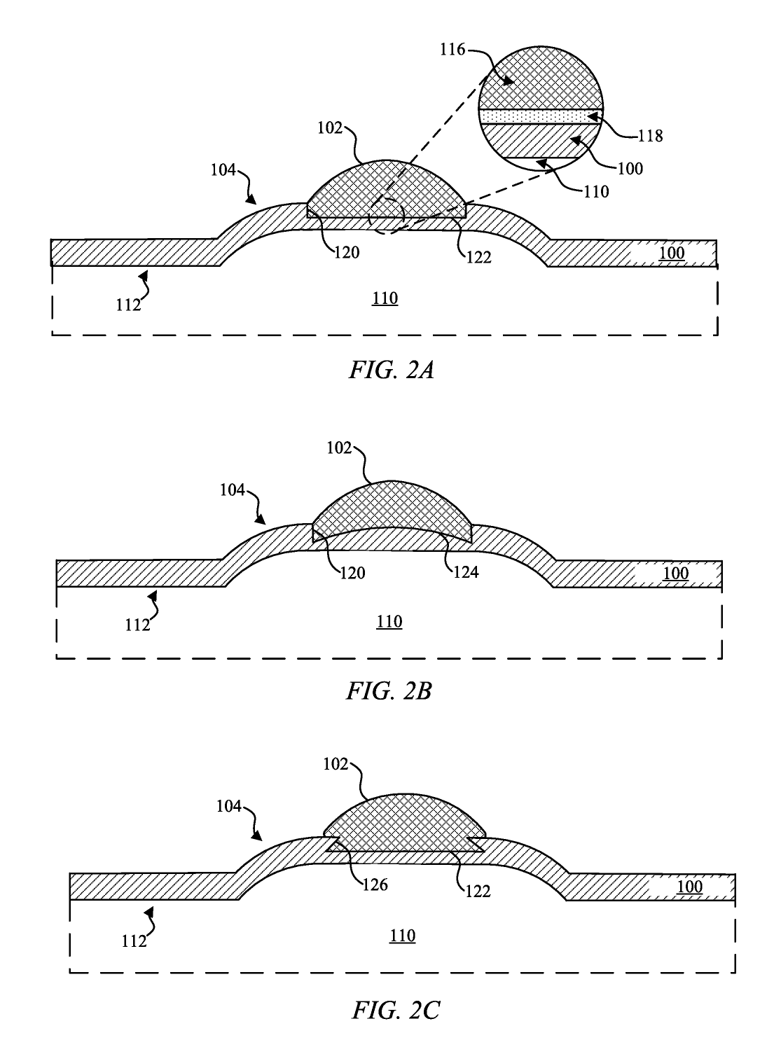

FIG. 2A illustrates an embodiment of the friction pad 102 residing exclusively on the first surface 104 of the device housing 100. Specifically, FIG. 2A shows the domed-profile of the friction pad 102 protruding away from the first surface 104 in order to provide an interface between the device housing 100 and a surface on which the device housing 100 can be placed on. Furthermore, the friction pad 102 can be made from a variety of materials including plastics, resins, polymers, solvents, or any suitable material for creating a self-profiling pad on a surface. Self-profiling refers to the ability of a material to naturally mold itself into a shape such as a dome, plateau, or any other suitable shape when the material is applied to a particular surface. In order to create a self-profiling pad, a variety of material properties should be considered. For example, viscosity can be important for setting a surface area that a deposited material will spread when the deposited material is applied to a surface. When a deposited material has a high viscosity, the maximum area will be smaller than when the deposited material has a low viscosity. Another important material property is the surface tension of the friction pad 102, as well as surface tension of the device housing 100. By adjusting the surface tension of the friction pad 102, the dimensions of the dome-profile of the friction pad 102 can be modified to create a steep or flat profile for the friction pad 102. The higher the surface tension of the friction pad 102, the more the friction pad 102 will resist gravity and maintain a naturally curved profile. Therefore, in some embodiments, the friction pad 102 has a surface tension that provides a dome-profile for the friction pad 102, and in other embodiments the friction pad 102 has a surface tension that provides a flat profile for the friction pad 102. Furthermore, in some embodiments, the surface tension of the first surface 104 at an area between the first surface 104 and the friction pad 102, or an area immediately surrounding the friction pad 102 on the first surface 104, can be adjusted to modify the shape of the friction pad 102. In this way, the friction pad 102 can be forced to reside over an area on the first surface 104 defined by the area of modified surface tension.

In some embodiments, values for static and dynamic friction of the friction pad 102 and the device housing 100 can be modified to provide adequate adhesion between the device housing 100 and the friction pad 102. Additionally, values for the static and dynamic friction of the friction pad 102 can be modified depending the external forces that the friction pad 102 may be expected to come into contact with (e.g., other computing device components, tables, idle or moving surfaces, liquids, skin, etc.). The friction pad 102 can be configured such that a coefficient of friction between the friction pad 102 and other surfaces (e.g., desks, wood, plastics, etc.) can provides a suitable amount of resistance when the friction pad 102 receives any opposing forces. In this way, any potential damage caused by friction between the friction pad 102 and an opposing surface can be mitigated while simultaneously ensuring that the friction pad 102 does not allow the computing device slide across the opposing surface during use of the computing device.

In some embodiments, material toughness (also referred to as fracture toughness) of the friction pad 102 can be altered to allow for some deformation of the friction pad 102 without creating fractures when the friction pad 102 is depressed or otherwise receives impact energy. The material toughness should be set at a value such that no fracturing of the friction pad 102 occurs, and if fracturing does occur, the friction pad 102 will resist further cracking as a result of subsequent external forces. The material toughness can be determined, at least in part, by the material density and molecular weight of the friction pad 102. Therefore, in some embodiments, by choosing a material having both a high density and high molecular weight (relative to other friction pad materials disclosed herein), the friction pad can exhibit a material toughness to resist fracturing caused by impacts to the computing device.

The friction pad 102 can be dyed a certain color, or a variety of colors in order to blend in with the rest of the computing device or exhibit some other suitable characteristic for the computing device. Additionally, friction pad can be dyed or given a certain material composition that provides the friction pad with a depth effect or some other textured effect. The texture can be one that blends into the surrounding computing device or one that is contrasted from the computing device. Moreover, various finishing processes can be used to ensure that the friction pad 102 can be created in a suitable shape and quality. For example, hot air can be used during and/or after the deposition of the friction pad 102 in order for the friction pad 102 to adequately form on and adhere to the first surface 104. If any air or bubbles are formed inside the friction pad 102 during the deposition process, a syringe or vibration process (under the direction of a person or robot) can be used to force the air from the friction pad 102 to provide a more uniform density for the friction pad 102, which in turn can lead to a longer lasting friction pad 102. In some embodiments, the friction pad 102 can be cured by an adhesive curing process. For example, ultra-violate light curing can be used to cure the friction pad 102, or any adhesive used to hold the friction pad 102 to the first surface 104, in order to permanently form the friction pad 102 in a suitable shape.

FIG. 2A illustrates an embodiment of the friction pad deposited on the first surface 104. Specifically, FIG. 2A shows a detailed view of the how layers of the friction pad 102, first surface 104, and an interfacing layer 118 are configured in some embodiments. The first surface 104 can be prepared in a variety of ways to receive the friction pad 102. In some embodiments where the device housing 100 includes aluminum, the friction pad 102 can be deposited onto the first surface 104 after the first surface 104 has received an anodized layer (i.e., the interfacing layer 118). In this way, the friction pad 102 would be deposited onto a layer of pores made of aluminum oxide resulting from the anodizing process. In some embodiments, the friction pad 102 can be deposited onto the first surface 104 after a laser etching process has removed a layer of anodized aluminum from the surface of the first surface 104. The first surface 104 can be conditioned in a number of ways before application of the friction pad 102. For example, an oleophobic coating (also illustrated in FIG. 2A as the interfacing layer 118) can be deposited onto the device housing in order to modify the surface tension of the device housing where the friction pad is going to be deposited. As discussed herein, by adjusting the surface tension of the device housing, the shape of the friction pad 102 can be modified. Any suitable means for modifying surface tension can be used in the embodiments described herein, including various machining and perforation processes wherein the shape and/or texture of a surface are modified mechanically for a given design.

As shown in FIG. 2A, the friction pad 102 can reside exclusively on the first surface 104 of the device housing, leaving the second surface 112 and interior portion 110 unaffected by the friction pad 102. The first surface 104 can be cut or machined to have a flat surface 122 for the friction pad 102 to abut. The friction pad 102 can be held in place at least by a wall 120 that is configured perpendicular to the flat surface 122. In FIG. 2B, the computing device housing 100 includes a curved surface 124 that can contribute to the shape of the friction pad 102. The angle between the wall 120 and the curved surface 124 can be less than 90 degrees, which also contributes to the shape of the friction pad 102 and the surface tension between the friction pad 102 and the first surface 104. In FIG. 2C, the first surface 104 can also be configured to have an inclined wall 126 adjacent to flat surface 122. The inclined wall 126 provides an extra means for the first surface 104 to grip the friction pad 102, and prevent the friction pad 102 from separating from the device housing 100.

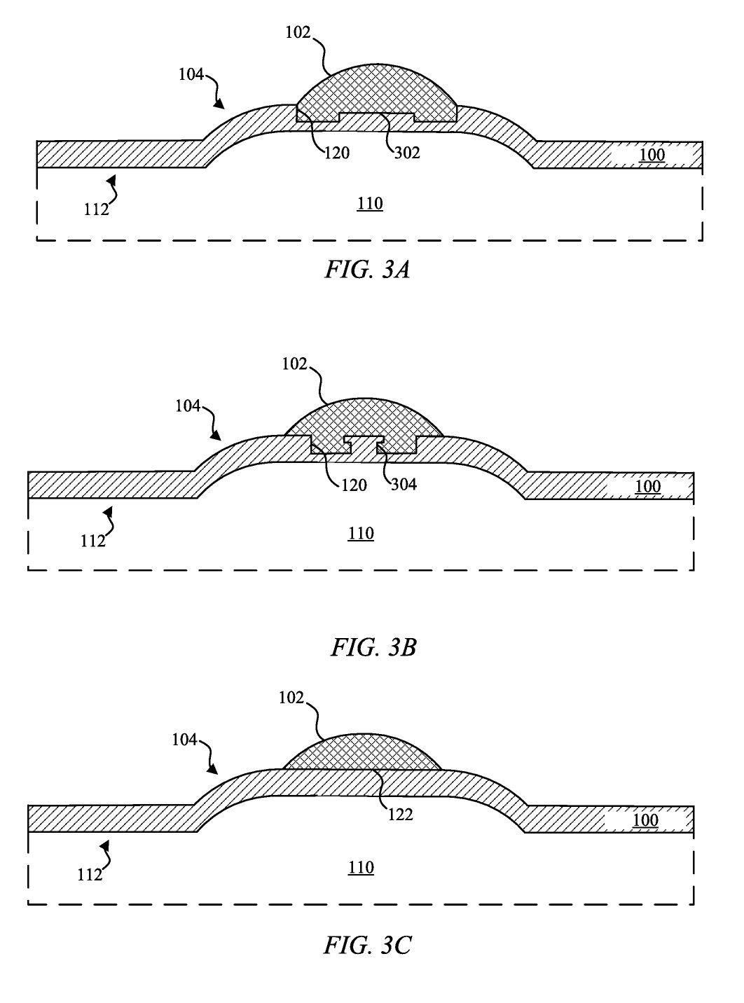

FIGS. 3A-3C illustrate various configurations for the friction pad 102 and device housing 100. Specifically, FIG. 3A illustrates an embodiment wherein a raised portion 302 can be used in combination with wall 120 to modify the profile of the friction pad 102. The raised portion 302 provides an extra level of support in order to push the friction pad 102 outward with respect to the interior portion 110. The raised portion 302 can be implemented in some embodiments where a natural profile of the friction pad 102 does not adequately protrude from the first surface 104. In some embodiments, the friction pad 102 has a circular shape, while in other embodiments the friction pad 102 can resemble a square, rectangle, or be molded into a line that defines a perimeter around the device housing 100. FIG. 3B illustrates an embodiment wherein an anchor 304 is configured adjacent to the wall 120 such that a portion of the anchor 304 will reside over a portion of the friction pad 102. In this way, the friction pad 102 can be held to the first surface 104 by the anchor 304 and any optional adhesive between the friction pad 102 and the first surface 104. FIG. 3C illustrates an embodiment wherein the first surface does not include a depression at the flat surface 122 for the friction pad 102 to reside in. Rather, the friction pad 102 is deposited directly onto the first surface 104. The friction pad 102 can be adhered to the flat surface 122 in any suitable manner, not limited to the mechanisms discussed herein. FIGS. 2A-3C can be combined, or duplicated, in any suitable configuration for providing a stable and smooth friction pad 102. For example, multiple anchors 304 of FIG. 3B can be used to ensure that the friction pad 102 is permanently interlocked to the first surface 104. Additionally, multiple curved surfaces 124 of FIG. 2B can be incorporated in some embodiments to provide a variety of profiles for the friction pad 102.

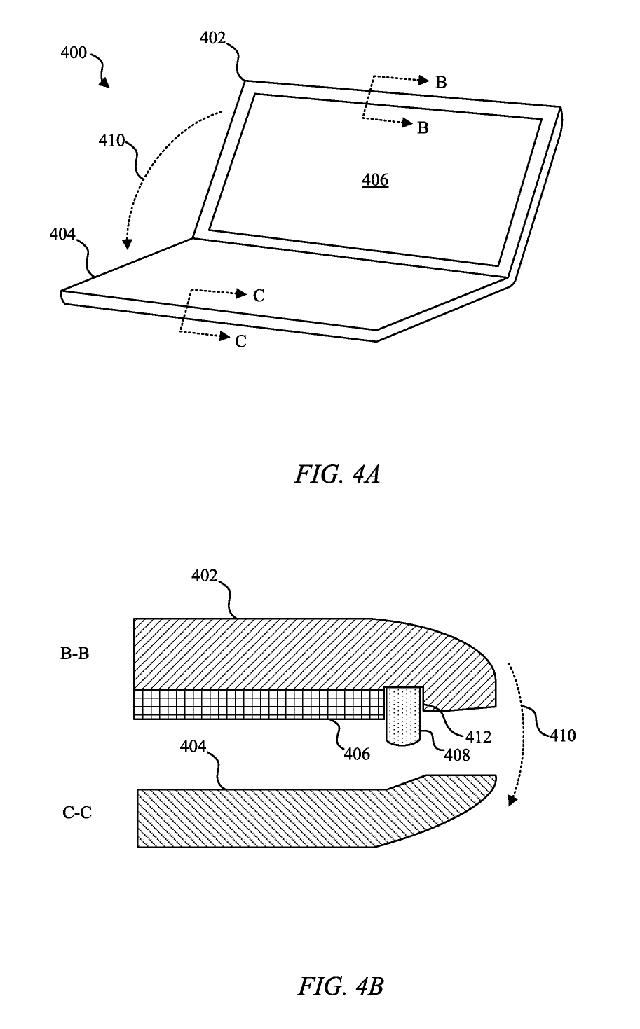

FIGS. 4A-4B illustrate a friction pad 408 incorporated into a perimeter of a computing device 400. Specifically, FIG. 4A shows a computing device 400 having a display 402 and a base 404. The display 402 includes a glass layer 406 for displaying an image to a user of the computing device 400. FIG. 4A includes cross sections B-B and C-C, which are further illustrated in FIG. 4B. FIG. 4B illustrates the computing device 400 in a closed arrangement. The computing device 400 closes through a path 410 wherein the display 402 can be rotated toward the base 404. The friction pad 408 can be configured to create a barrier between the base 404 and the glass layer 406. Because the base 404 can be made from hard materials such as aluminum, the glass layer 406 should be protected from impacts when closing the computing device. However, incorporating the friction pad 408 into a gap 412 can require that the glass layer 406 be offset from the edge of the edge of the display 402 to make room for the friction pad 408. Moreover, the gap 412 can unintentionally provide a path for water or electrostatic discharge to move into the computing device 400. The embodiments set forth herein are intended to cure these issues.

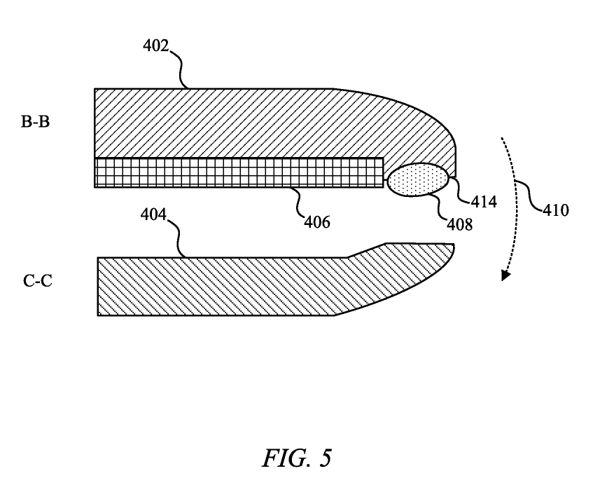

FIG. 5 illustrates the friction pad 408 deposited into a perimeter of a computing device 400 (illustrated in FIG. 4A). The friction pad 408 can be configured on an outer most edge of the display 402, which can be modified in order to cause the deposited friction pad 408 to form a dome-shaped profile when the deposited friction pad 408 hardens. As a result, more space for the glass layer 406 is provided, reducing the chances of destructive impacts to the glass layer 406. Moreover, the friction pad 408 can be configured to seal the display 402 and base 404 when the computing device 400 is in a closed position. In this way, there is less of an opportunity for water to enter the computing device, and less of a pathway for electrostatic discharge to affect internal components of the computing device 400. In some embodiments, the display 402 and base 404 can include a metal (e.g., aluminum), plastic, or any suitable computing housing material. The cross section of the friction pad 408, as illustrated in FIG. 5 can be configured in any suitable arrangement discussed herein. For example, the edge of the display 402 can resemble the anchor 304 of FIG. 3B. Moreover, the friction pad 408 can include any suitable materials discussed herein, and be modified to include any of the material properties discussed herein. In summary, the friction pad 408 can be the same as friction pad 102 discussed herein, except that friction pad 408 is disposed around a perimeter of a display 402.

The friction pad 408 of FIG. 5 can be disposed on the display 402, the base 404, or both concurrently. The friction pad 408 is illustrated as exclusively abutting the display 402, and not contacting the glass layer 406. Additionally, the display 402 can include a depression for the friction pad 408 to reside in, similar to friction pad 102 of FIG. 2A. The friction pad 408 can be configured to abut the base 404 in closed position while concurrently maintaining the glass layer 406 a distance above the base 404. In this way, the glass layer 406 can be protected from receiving forces of impact when a user closes the computing device 400 by way of path 410. Furthermore, the friction pad 408 can be configured to a have a diameter that is greater than half a width of a display edge 414, as illustrated in FIG. 5. The width of the display edge 414 is defined by a distance between a distal end of the glass layer 406 and the outer most edge of the display 402. The friction pad 408 can also have a diameter less than half a width of the display edge 414. The friction pad 408 can be configured such that a majority of the friction pad 408 resides outside of the display edge 414 or, alternatively, inside of the display edge 414.

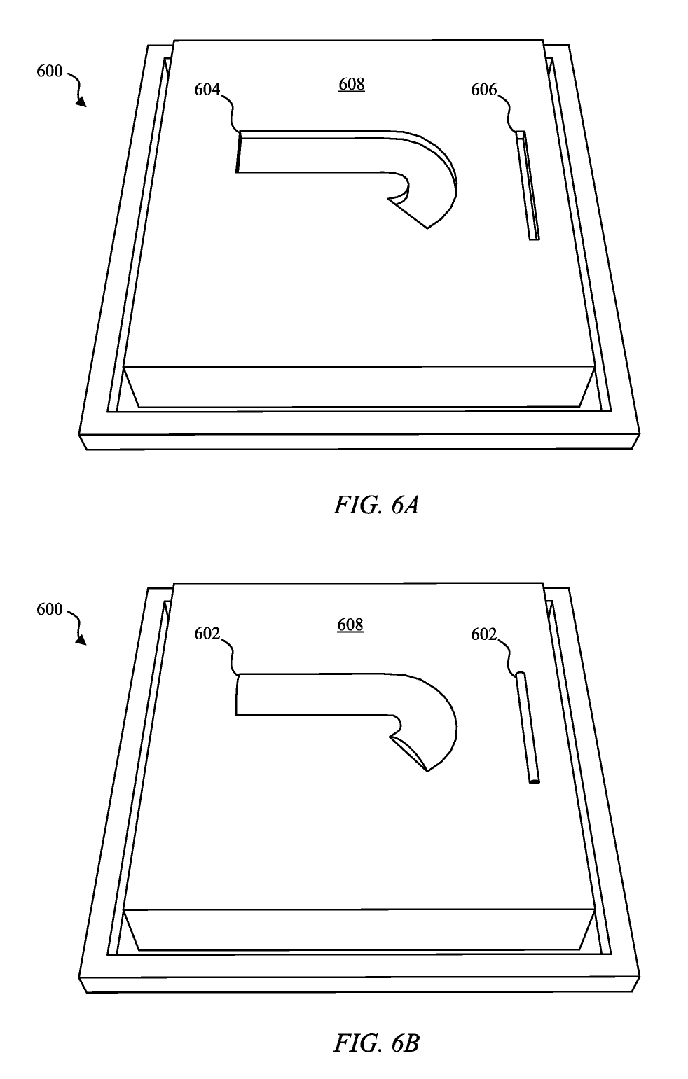

FIGS. 6A-6B illustrate an embodiment wherein the friction pad 602 is incorporated into a key 600 of a keyboard. In some embodiments, the friction pad 602 can be deposited into the letter depression 604 and/or reference depression 606 of a key 600 on a keyboard. As illustrated in FIG. 6B, by depositing the friction pad 602 into the key 600, a protruding layer can extend from a surface of the key 600 so that a user of the key 600 can more readily feel and locate the key as the user types. The friction pad 602 and surface 608 can be configured in any suitable manner discussed herein with respect to friction pad 408 and friction pad 102. For example, the surface tension of the friction pad 602 can be modified to give the friction pad 602 a steeper or flatter profile to compliment the functionality of the key 600. Moreover, the friction pad 602 can be dyed or colored in order to provide better visibility of the key 600 to a user, or to soften portions of the key 600 to better absorb impact forces from the user. Additionally, the letter depression 604 and reference depression 606 can be modified to be more or less deeper in order to create a variety of profiles for the friction pad 602. In some embodiments, a majority of the volume of the friction pad 602 resides above the surface 608 of the key 600. Alternatively, in some embodiments a majority of the volume of the friction pad 602 resides below the surface 608. Moreover, the surface tension of surface 608 of the key 600 can be modified to maintain a domed profile for the friction pad 602.

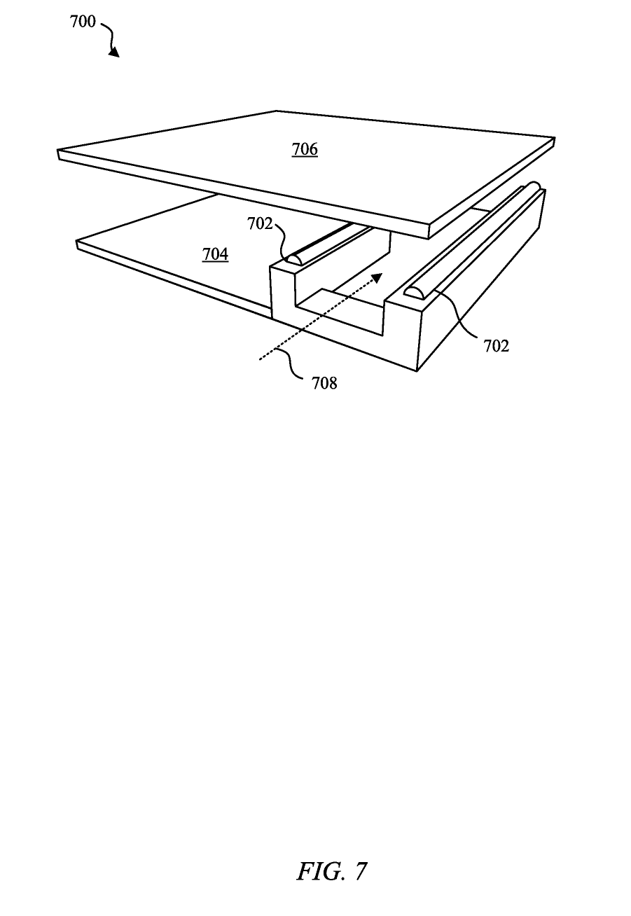

FIG. 7 illustrates an embodiment where the friction pad 702 is used to seal a ventilation system 700 of a computing device. In particular, FIG. 7 shows a first device base 704 having a duct system formed on the surface of the first device base 704 to allow a passage 708 for air to move through the computing device and cool the computing device. The friction pad 702 can act as a seal for the ventilation system 700 when the second device base 706 is depressed against the first device base 704. The friction pad 702 can be modified in any suitable manner as discussed previously with respect to friction pad 102, 402, and 602. Moreover, the materials used on the first device base 704 can be modified in any suitable arrangement as discussed herein. For example, the surface tension of the first device base 704 can be adjusted to ensure that the friction pad 702 retains a firm profile in order to adequately seal the passage 708. Moreover, the first device base 704 and/or the second device base 706 can include depressions or machined areas in order to make the ventilation system thinner, and to better retain the friction pad 702 along the course of the passage 708.

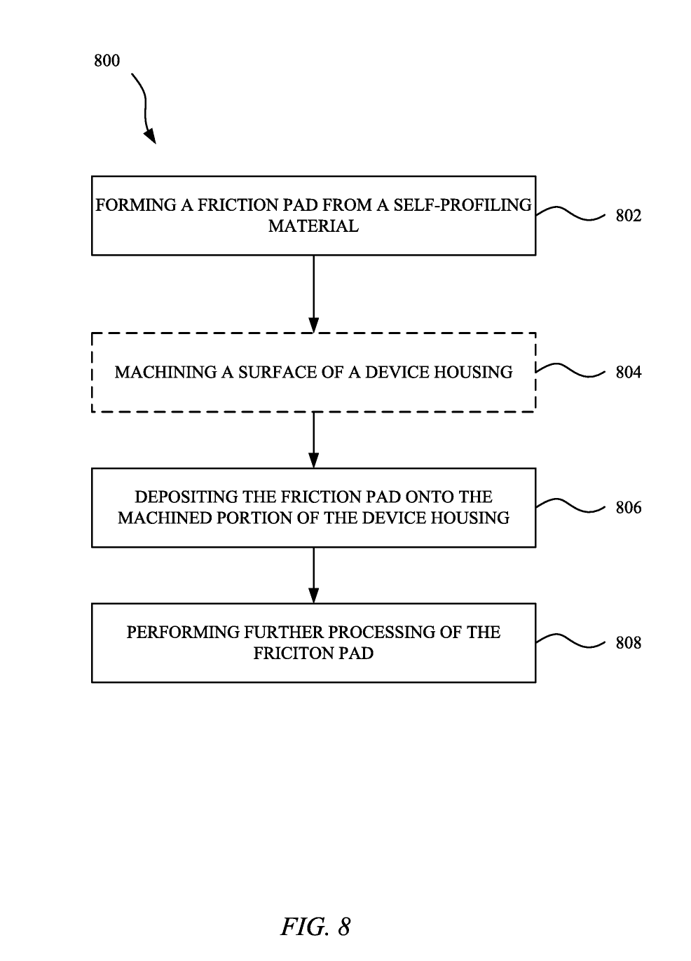

FIG. 8 illustrates a method 800 for applying a friction pad to a computing device. Specifically, FIG. 8 outlines forming the friction pad and applying the friction pad to a surface of the computing device. The method 800 includes a step 802 of forming a friction pad from a self-profiling material. Next, the option step 804 is performed wherein a portion of the surface of the device housing is machined away. At step 806, the friction pad is deposited onto the machined portion of the device housing. Finally, at step 808, further processing of the friction pad is performed, which is also an optional step. The method 800 can be modified in any suitable manner according to any of the embodiments discussed herein.

The various aspects, embodiments, implementations or features of the described embodiments can be used separately or in any combination. Additionally, the foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A computing device housing, comprising:
a surface, wherein the surface includes a depressed portion that is recessed from an adjacent portion of the surface, the depressed portion comprising a base portion and wall portion concurrently abutting a self-profiling material deposited within the depressed portion, wherein the self-profiling material:
comprises a thermoplastic material,
forms a dome-shaped profile based on a material property of the depressed portion, and
exclusively abuts the surface of the computing device housing.

2. The computing device housing of claim 1, wherein the material property is a surface energy.

3. The computing device housing of claim 1, wherein a surface energy of the base portion is different than a surface energy of the adjacent portion.

4. The computing device housing of claim 1, wherein the surface is a perimeter of a display for a computing device, and the depressed portion surrounds a glass layer of the display.

5. The computing device housing of claim 1, wherein the surface is a portion of a laptop, and the self-profiling material is configured to be an interface between the surface and an idle surface on which the laptop can be placed.

6. The computing device housing of claim 1, wherein the surface is an air duct for a computing device and the self-profiling material is configured to seal a region of the air duct.

7. The computing device housing of claim 1, wherein the surface comprises anodized aluminum.

8. The computing device housing of claim 1, wherein the base portion includes an oleophobic coating that abuts the self-profiling material.

9. The computing device housing of claim 1, wherein the surface has a surface energy higher than a surface energy of the self-profiling material.

10. A method for applying a self-profiling pad to a surface of a computing device, the method comprising:
depositing a self-profiling material to the surface of the computing device while the self-profiling material is in a liquid state, wherein the self-profiling material comprises a thermoplastic polymer; and
causing the self-profiling material to transition into a solid state and form a dome-shaped profile exclusively across the surface of the computing device.

11. The method of claim 10, further comprising:
machining a portion of the surface to have a uniform base portion that is recessed from an adjacent portion of the surface.

12. The method of claim 10, further comprising:
modifying a surface tension of the surface of the computing device at a region that is to receive the self-profiling material.

13. The method of claim 10, wherein the surface of the computing device comprises anodized aluminum.

14. The method of claim 10, further comprising:
depositing an oleophobic coating onto the surface to alter a surface tension of a region between the self-profiling material and the surface.

15. A self-profiling pad for a computing device, comprising:
a body made of a thermoplastic material;
a first surface having a dome-shaped profile;
a second surface that is substantially flat and is configured to exclusively abut one side of a housing of the computing device; and
a lateral portion configured to abut a depressed portion of the housing on at least two surfaces of the depressed portion.

16. The self-profiling pad of claim 15, wherein a surface tension of the self-profiling pad is configured to cause the self-profiling pad to form the dome-shaped profile after the thermoplastic material is deposited onto the depressed portion.

17. The self-profiling pad of claim 15, wherein the self-profiling pad is configured to surround a perimeter of a display of the computing device.

18. The self-profiling pad of claim 15, wherein the self-profiling pad is configured to seal an air duct of the computing device.

19. The self-profiling pad of claim 15, wherein the depressed portion is a letter or guide on a key of a keyboard, and the self-profiling pad is configured to at least partially reside in the key.

20. The self-profiling pad of claim 15, wherein the second surface includes an oleophobic coating.
